(19) United States
(12) Patent Application Publication
(10) Pub. No.: US 2024/0412619 A1
(43) Pub. Date: Dec. 12, 2024

(54) WEARABLE PERSONAL SAFETY DEVICE WITH A REAL TIME CRISIS RESPONSE SMART PHONE APPLICATION

(71) Applicant: SafetyChick Technology Corporation, Fort Lauderdale, FL (US)

(72) Inventor: Kathleen Gallagher, Fort Lauderdale, FL (US)

(21) Appl. No.: 18/332,741

(22) Filed: Jun. 11, 2023

(51) Int. Cl. G08B 25/01; G08B 25/10; H04W 4/90

(52) U.S. Cl. CPC G08B 25/016; G08B 25/10; H04W 4/90

(57) ABSTRACT

The present invention relates generally to a wearable personal safety device that offers real time crisis response through an innovative smart phone application. The wearable device can take the form of several different types of jewelry each of which contain a discrete alert button known as the SidePeace, that the wearer can activate to communicate instantaneously with public safety officials as well as the wearer's Life-Lines personal safety group. This communication is accomplished via the innovative smart phone application. The present invention has wide applicability to other individuals who suffer medical emergencies and want to summon help quickly.

### CROSS-REFERENCE TO RELATED APPLICATIONS

This non-provisional patent application claims priority to U.S. Provisional Patent Application No. 63/366,271, “Wearable Personal Safety Device with a Real Time Crisis Response Smart Phone Application” filed on Jun. 13, 2022.

### FEDERAL RESEARCH STATEMENT

None

### FIELD OF THE INVENTION

The present invention relates generally to an integrated wearable personal safety device that offers real time crisis response through an integrated and innovative smart phone application. The wearable device can take the form of several different types of jewelry each of which contains a discrete button that the wearer can activate to communicate instantaneously with public safety officials as well as the wearer's Life-Line personal safety group. This communication is accomplished via the innovative smart phone application.

### BACKGROUND OF THE INVENTION

Dangerous situations come about quickly. They often arise in a split second and come as a complete surprise. These situations put women at risk. The ability to access your phone to call is not always a viable option. Crime is on the rise. Criminals are being released early from prison at an alarming rate. Many crimes are not investigated and arrested criminals are often back on the street almost immediately. At the same time, the number of people in law enforcement is declining, resulting in fewer police in the communities and slower response times. In a dangerous situation, the only ones you can truly count on to get you help quickly and efficiently in your time of greatest need are the people who care about you the most: your Life-Lines (Family, Friends, Roommates, Co-Workers, etc.). In order to facilitate understanding of the aspects of the present invention, the close community of friends, family, co-workers, students, etc most knowledgeable about an individual and their proclivities will be referred to throughout this application as an individual's Life-Lines.

The present invention addresses the problems stated above by disclosing an invention and integrated product known commercially as the SidePeace Safety Wearable/Real-Time Crisis Response (RTCR) Device and smartphone App. The SidePeace Bluetooth alert button pops into the SafetyChick Custom bracelet, and is interchangeable with and can be placed into other wearable accessories. A simple press of the alert button in the bracelet launches the App on your smartphone and sends an emergency alert to your Life-Lines, tracks your GPS location and gives Life-Lines a prompt to call/text directly to the 911 center closest to you. The App also allows group texting so Life-Lines can share vital information with 911 call centers and dispatchers in real-time. The App must be installed on the individual's smartphone. The terms “SidePeace”, “alert button” and “panic button” will be used interchangeably throughout this application.

### DESCRIPTION OF THE PRIOR ART

There are several examples of personal safety devices in the prior art. The most relevant are the following:

U.S. Pat. No. 10,299,103 Power Management Techniques for Increasing Battery Life in an Alert Generation System issued to Invisawear Technologies LLC on May 21, 2019. This disclosure provides systems and methods for providing an emergency alert notification.

U.S. Pat. No. 10,553,102 Methods and Apparatuses for Personal Safety issued to Ripple Network Technologies, Inc. on Feb. 4, 2020. A discrete wearable device having a tactile switch, wireless connection capabilities, and is integrated with a personal security, concierge, or service system. The device integrates with accessories such as personal articles like zippers and bra straps and with containers such as a case, cover, or jewelry locket.

U.S. patent application Ser. No. 17/289,577 Methods and Devices for Messaging Within a Personal Security Network filed by Flare Jewelry, Inc. on Jan. 13, 2022. Methods and devices using a portable or wearable transistor configured to send an alert message to a personal security network. The personal security network comprises a platform by which Victims can select an appropriate alert response to a particular social interaction or event.

While the prior art referenced above contains elements of the instant invention, the innovative SidePeace button and innovative smart phone application featuring Life-Lines are new and unique within the space.

### SUMMARY OF THE INVENTION

The present invention discloses an integrated personal safety system that includes the following attributes:
a. a panic button called the SidePeace embedded in wearable jewelry
b. a real time crisis response app installed on a smart phone.
c. a method for communication between the panic button when it is depressed by an individual in distress.

The SidePeace panic button is the essence of the present invention. The SidePeace is designed so that it can be embedded in several different types of jewelry as is shown in FIG. 4. The SidePeace alert button is modular so that it can be inserted quickly and snuggly in the various pieces of jewelry.

The SidePeace communicates with a smart phone via Bluetooth or any other similar communication method. It includes a push button and internal circuitry that activates the Bluetooth transmitter and sends a signal to the smart phone. The smart phone app initiates the safety and security protocol alert which immediately notifies people identified as the victim's Life-Lines—i.e. good friends, roommates and family who are most concerned with the safety and security of the victim.

The alert connects Life-Lines to the app and sends a satellite map location of the victim, starts tracking the victim and initiates a prompt to call the 911 call/dispatch center closest to the victim. There is also a prompt so that the Life-Lines can engage in group chats and posts.

When the designated Life-Line contacts the closest 911 call/dispatch center to the victim, 911 dispatches law enforcement to the victim's location. The app also shares information about the victim so that law enforcement can more easily identify her. This information may include a picture, height, weight, hair color, eye color, etc. The Life-Line community stays online and in contact with each other until such time as the situation is resolved. In order to facilitate understanding of the present invention, the discrete button that is embedded in the wearable jewelry will be referred to in this patent application by its commercial name SidePeace. In addition, the real time crisis response smartphone application will be referred to as the RTCR App and the group of family, friends, co-workers and other support personnel will be referred to as “Life-Lines”. In addition, the person using the instant invention will be referred to as the victim in order to facilitate understanding.

### BRIEF DESCRIPTION OF THE DRAWINGS

FIG. 1 is an overview of the present invention.

FIG. 2 is an overview of the present invention showing how the invention is practiced.

FIG. 3 is an example of what the app looks like on a smart phone.

FIG. 4 shows the types of jewelry that the present invention can be incorporated into.

FIG. 5 shows the various views and dimensions of the SidePeace.

FIG. 6 is an exploded view of the SidePeace.

### DETAILED DESCRIPTION OF THE INVENTION

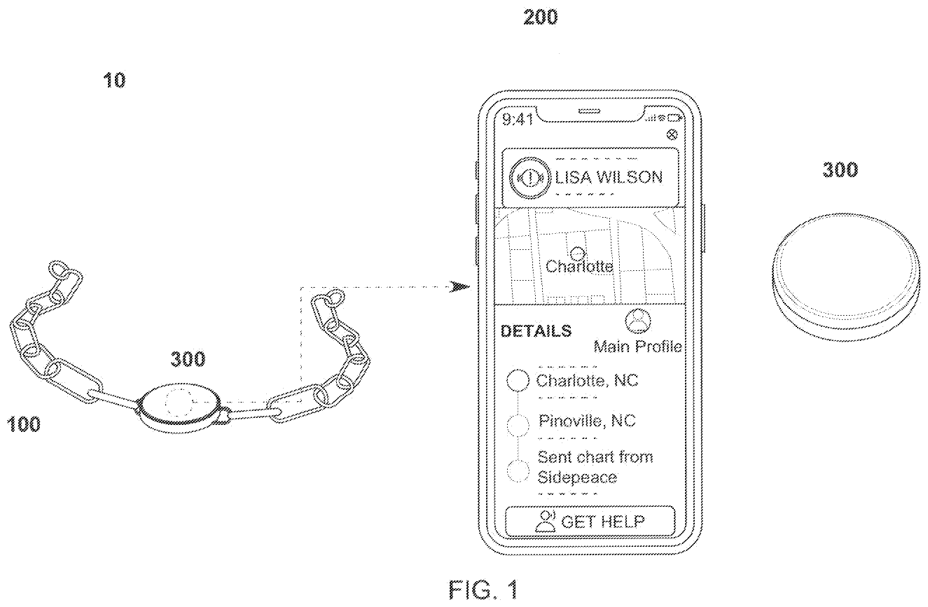

Referring to FIG. 1, an overview of the present invention 10 is shown, including one manifestation of the wearable jewelry 100 with the SidePeace 300 inserted, the SafetyChick app 200 shown on a smartphone and an enlarged view of the SidePeace 300. Several different types of wearable jewelry may be used including bracelets, necklaces, pendants, sports bands, etc. The only requirement with respect to the jewelry is that it be so configured so that the SidePeace can be snuggly inserted. As such the SidePeace is modular and can be easily snapped into and removed from the wearable jewelry.

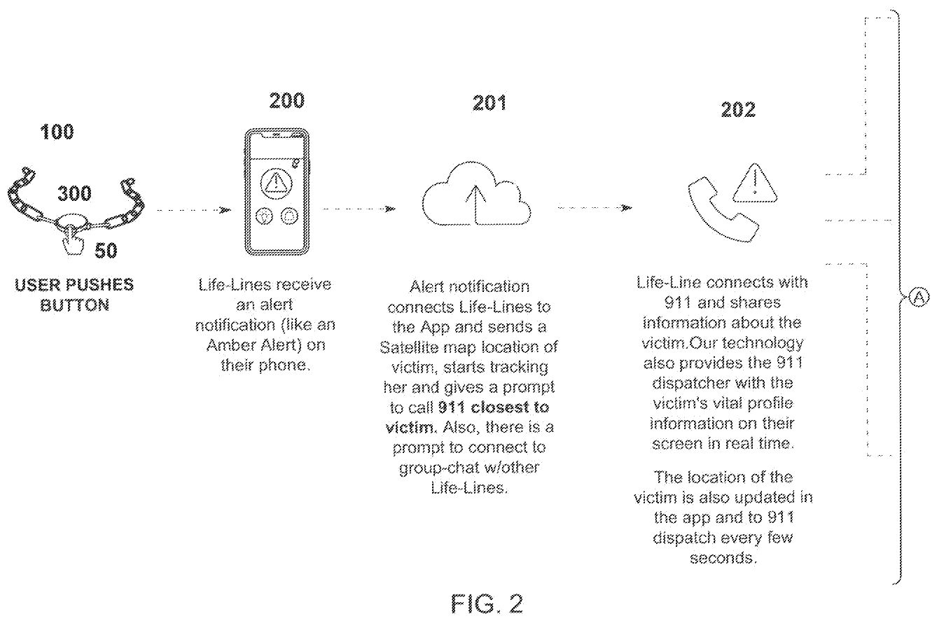

Referring to FIG. 2, an overview of the operation of the present invention is shown. Whenever a user 50 determines they are in danger, they press the button 300 on the SidePeace. This actuates the Bluetooth on the SidePeace and sends a signal to the RTCR App on their smartphone 200. The SidePeace may include a mechanism to provide an audible beep or click when the button is pressed. This informs the individual that the SidePeace has in fact sent the alert signal to the smartphone. The RTCR App immediately sends an alert 201 to designated family, friends, co-workers and other support personnel (i.e. the Life-Lines). The application also sends an alert to the smartphone such that the smartphone beeps or emits another audible sound to the let the individual know that the RTCR App has initiated the alert signal to the Life-Lines. Additional audible sounds may be sent to the smartphone as members of the Life-Line community join the group chat. It also sends a map of the location where the SidePeace was activated, and starts tracking the victim. The Life-Lines enter a group chat screen 206 where they can share details about the victim with each other that might be of help with the emergency. The screen also has a prompt 205 to call/connect with the 911 Call Center closest to the victim's location. The 911 Call Center closest to the victim dispatches first responders 204.

The Life-Lines may share personal data 202 about the victim including height, weight, hair color, ethnicity, distinctive markings such as tattoos, medical condition and any other information that will help first responders quickly identify and assist the victim. The 911dispatcher also sees the victim's profile information and location on their screen as well. The 911 call center technology systems are connected with the RTCR technology.

The RTCR App updates the victim's location in the event they are transported.

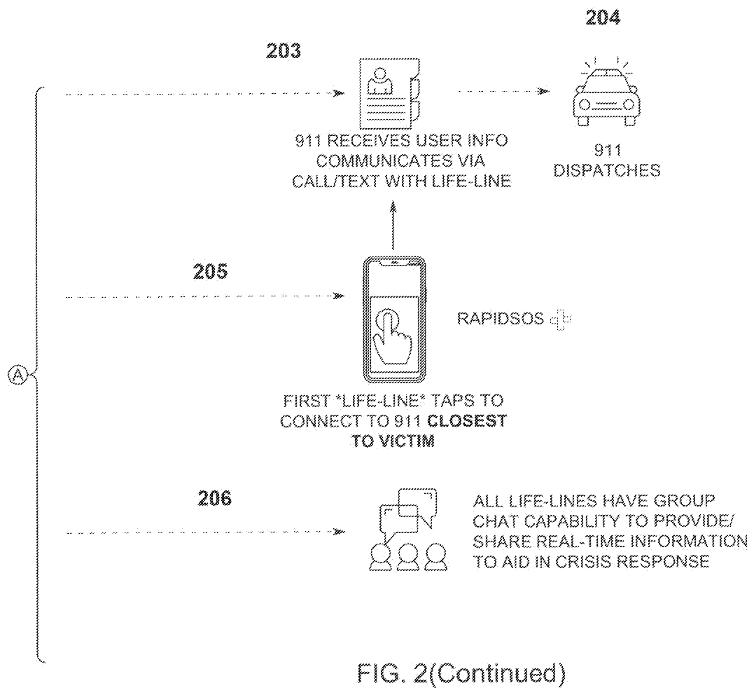

Referring to FIG. 3, a sample screen from the RTCR App 200 on a smartphone is shown showing the type of information that can be passed along to first responders. The more information the police or other first responders have about the victim, the greater the likelihood of rendering assistance quickly.

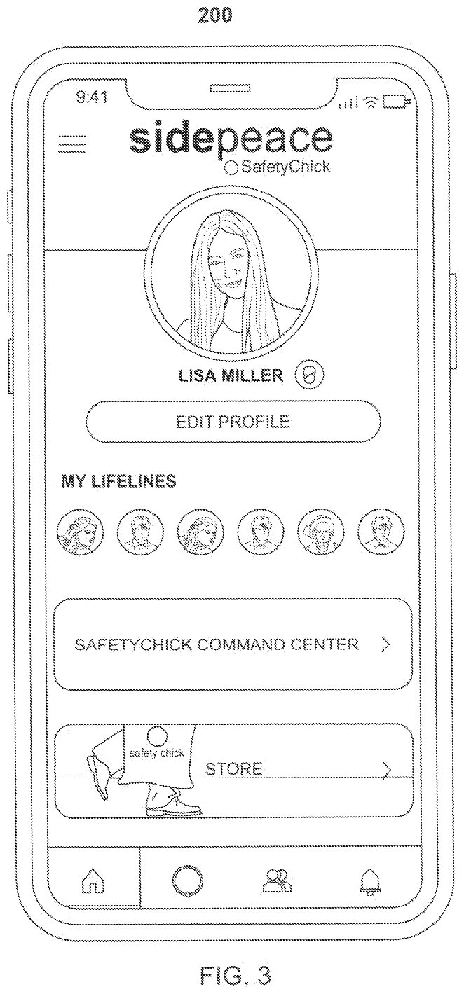

Referring to FIG. 4, the wearable jewelry 100 with the SidePeace 300 in place on the victim's wrist is shown. It is important to note that the wearable jewelry can take many forms. It can be a bracelet, sports band, keychain, pendant, necklace, or any other type of jewelry. The only requirement is that the jewelry incorporate a means for inserting and firmly holding in place the SidePeace. Users may choose to wear multiple forms of jewelry with the SidePeace alert button installed. The SidePeace may incorporate a beep or audible click to let the individual know for sure that the alert has been sent. In addition, the smartphone may include an audible noise that informs the individual that the alert has been received and

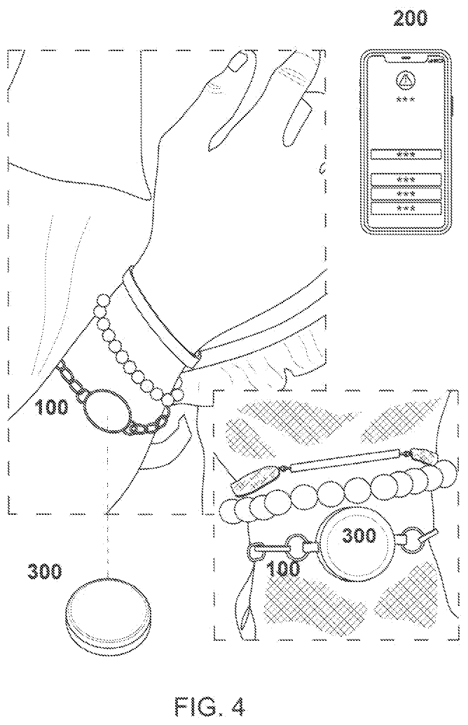

Referring to FIG. 5, top and side views of the SidePeace button 300 are shown. The button is optimally round or slightly oblong in shape. The nominal dimensions are less than one inch in diameter and less than half an inch in overall height. In the best mode, the diameter is between 0.75 inches and 1.25 inches and the overall height is between 0.25 inches and 0.60 inches. The approximate sizes ensure that the alert button is large enough that it be found and pressed quickly, yet small enough that it looks like just another part of the wearable jewelry. In the best mode, the physical appearance of the SidePeace button is of a truncated right circular cylinder with rounded edges. In other modes, the physical appearance may be a slightly elongated truncated right circular cylinder with rounded edges to conform to variations in the aperture in the jewelry in which the SidePeace is inserted. The module may be easily disassembled to allow replacement of the battery.

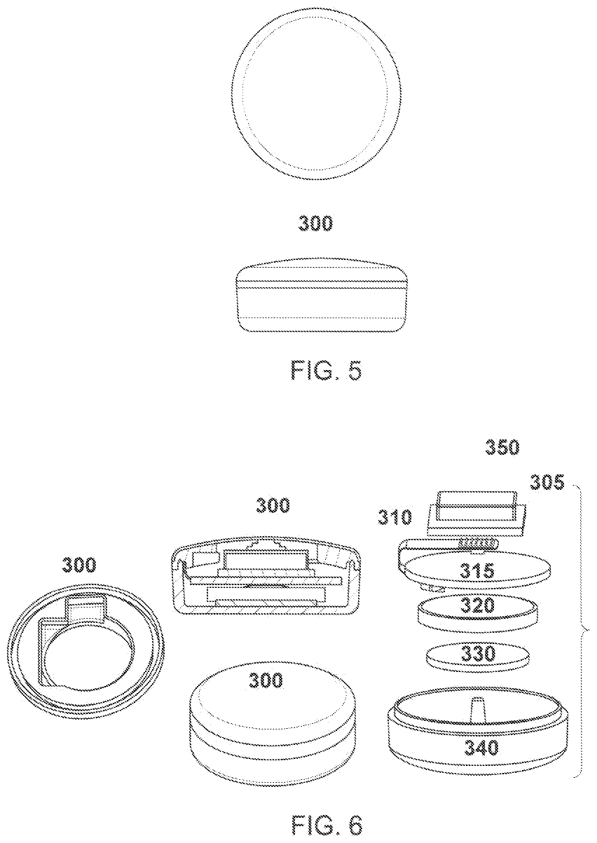

Referring to FIG. 6, the nominal detailed components of the SidePeace button 300 are shown. In the best mode, the following components comprise the SidePeace button as shown in the exploded view 350: an electronic module 305, a flex printed circuit board (PCB) with switch 310, a carrier printed circuit board (PCB) 315, a battery 320, a foam pad 330, and a lower housing 340. Other variations of the SidePeace may incorporate other components reflecting advances in technology including longer life batteries, smaller components, voice activated emergency signals, extended range transmitters, etc. The components are also shown in a side view and a perspective view.

While the foregoing presents the basics of the instant invention, various combinations and permutations of the components disclosed can be combined to form additional products that can be of use to individuals who may become victims and their friends and families.

The present invention has been described and demonstrated in terms of a woman who is being stalked, threatened, and even attacked. However, the capabilities of the present invention extend to other members of society. For example, elderly women may choose to wear a more fashionable device such as the present invention rather than the cumbersome and plain alert products that are currently available on the market. It can also be used by adults and children who are susceptible to medical emergencies such as seizures, diabetic issues, heart problems, dizziness, etc. When such an individual feels the onset of a medical emergency, by simply pressing the SidePeace button, he or she can alert his or her Life-Lines and begin to get assistance quickly. Mental Health emergencies are also a consideration for use of the SidePeace. Any man or woman struggling with mental health issues can press the button to get help, and even connect with the Suicide Hot-Line. People with physical disabilities/handicapped also benefit by wearing the SidePeace for their safety as well.

The invention claimed is:

1. An integrated personal safety and alert system comprising:
a. a panic and safety alert button embedded in jewelry that may be worn on the person of an individual;
b. a real time crisis response application installed on a smart phone; and
c. a means for enabling communications between the panic button and a smart phone when the panic button is depressed by an individual.

2. The integrated personal safety and alert system as in claim 1 wherein the panic button may be inserted into any one of several different types of jewelry that may be worn by an individual.

3. The integrated personal safety and alert system as in claim 1 wherein the panic button communicates with the smart phone application by Bluetooth.

4. The integrated personal safety and alert system as in claim 1 which can notify family, friends, co-workers, support personnel and first responders when an individual encounters a stressful situation.

5. The integrated personal safety and alert system as in claim 1 wherein the jewelry may be a bracelet, a sports band, a necklace, a pendant, or a keychain.

6. A panic and alert button electronic module embedded in jewelry that is part of an integrated personal safety system that may be worn by an individual comprising the following:
a. a flex printed circuit board with switch;
b. a carrier printed circuit board;
c. a battery;
d. a foam pad; and
e. a lower housing.

7. A panic and alert button electronic module as in claim 6 that may be activated by an individual pressing the button.

8. A panic and alert button electronic module as in claim 6 wherein the electronic module communicates with a smart phone application via Bluetooth or other similar communication mechanism.

9. A panic and alert button electronic module as in claim 6 wherein said button is modular and can be inserted in and removed from several different types of wearable jewelry.

10. A panic and alert button electronic module as in claim 6 wherein said module relatively flat right circular cylinder with rounded edges and measures between 0.25 and 0.60 inch in height and between 0.75 and 1.25 inches in diameter.

11. A panic and alert button electronic module as in claim 6 wherein said module is a relatively flat right circular cylinder with rounded edges and measures between 0.35 and 0.50 inch in height and between 0.80 and 1.10 inches in diameter.

12. A panic and alert button electronic module as in claim 6 wherein the module can be disassembled to replace the battery.

13. A panic and alert button electronic module as in claim 6 wherein an audible beep or click lets the individual know that the alert has been transmitted to the smartphone.

14. A smartphone application integrated with a panic and alert button embedded in jewelry comprising the following functions:
a. receiving a signal from the panic and alert button when said button is pressed by an individual in distress;
b. transmitting an alert to designated family, friends, co-workers and support personnel;
c. enabling a group chat among designated family, friends, co-workers and support personnel;
d. prompting designated family, friends, co-workers and support personnel to connect with the 911 emergency call center closest to the location of the person in distress who pressed the panic and alert button;
e. transmitting a map of the location where the distressed person activated the panic and alert button to designated family, friends, co-workers, support personnel and first responders;
f. tracking the location of the person who pressed the panic and alert button and informing first responders as the distressed person moves; and
g. enabling designated family, friends, co-workers and support personnel to provide additional personal information about the distressed individual to first responders.

15. The smartphone application of claim 14 where family, friends, co-workers, support personnel remain in contact with each other until such time as the situation is resolved.

16. The smartphone application of claim 14 wherein a picture of the distressed individual.

17. The smartphone application of claim 14 wherein the information is updated continuously.

18. The smartphone application of claim 14 wherein the application sends a beep tone to the smartphone indicating that the alert has been received.

19. The smartphone application of claim 14 wherein the application sends a further audible tone or beep to the smartphone informing the individual that an alert signal has been transmitted to family, friends, co-workers, support personnel and first responders.
